(19) United States
(12) Patent Application Publication
(10) Pub. No.: US 2024/0200437 A1
(43) Pub. Date: Jun. 20, 2024

(54) INSTRUMENTED SUB

(71) Applicant: Nabors Drilling Technologies USA, Inc., Houston, TX (US)

(72) Inventors: Sergei Knizhnik, Exton, PA (US); Scott Boone, Houston, TX (US); Christopher Conrad, Glen Mills, PA (US); Maciej Panek, West Chester, PA (US); Edward J. Harris, III, Pottstown, PA (US)

(21) Appl. No.: 18/540,539

(22) Filed: Dec. 14, 2023

Related U.S. Application Data
(60) Provisional application No. 63/387,865, filed on Dec. 16, 2022.

(51) Int. Cl. E21B 44/04; E21B 47/007

(52) U.S. Cl. CPC E21B 44/04; E21B 47/007

(57) ABSTRACT

An instrumented sub is provided that can include an upper portion and a lower portion of a body, the body having a flow passage extending through the upper portion and the lower portion, and an instrumented clamp that can be removably attached to the body between the upper portion and the lower portion, where the instrumented clamp can be electrically coupled to the body via a first electrical coupling of the instrumented clamp being mated to a second electrical coupling mounted to the body. A method is also provided for attaching an instrumented clamp to a body before or after the body is coupled to the top drive, transmitting signals between the instrumented clamp and a rig controller; and removing the instrumented clamp from the body while the body remains coupled to the top drive.

### CROSS-REFERENCE TO RELATED APPLICATION(S)

This application claims priority under 35 U.S.C. § 119(c) to U.S. Provisional Application No. 63/387,865, entitled “INSTRUMENTED SUB,” by Sergei KNIZHNIK et al., filed Dec. 16, 2022, which is assigned to the current assignee hereof and incorporated herein by reference in its entirety.

### FIELD OF THE DISCLOSURE

The present invention relates, in general, to the field of drilling and processing of wells. More particularly, present embodiments relate to a system and method for measuring performance of and providing feedback to control equipment utilized for a subterranean operation.

### SUMMARY

This summary is provided to introduce a selection of concepts that are further described below in the detailed description. This summary is not intended to identify indispensable features of the claimed subject matter, nor is it intended for use as an aid in limiting the scope of the claimed subject matter.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes an instrumented sub for supporting subterranean operations. The instrumented sub also includes a body may include an upper portion and a lower portion, where the body is configured to be coupled between a top drive and a tubular string; a flow passage extending through the upper portion and the lower portion; and an instrumented clamp that is removably attached to the body between the upper portion and the lower portion, where the instrumented clamp is electrically coupled to the body via a first electrical coupling mated to a second electrical coupling, with the first electrical coupling being mounted to the instrumented clamp and the second electrical coupling being mounted to the body. Other embodiments of this aspect include corresponding computer systems, apparatus, and computer programs recorded on one or more computer storage devices, each configured to perform the actions of the methods.

One general aspect includes a method for performing a subterranean operation. The method also includes coupling a body of an instrumented sub between a top drive and a tubular string; attaching an instrumented clamp to the body, where the instrumented clamp is axially spaced away from either end of the body; transmitting one or more communication signals between the instrumented clamp and a rig controller; and removing the instrumented clamp from the body while the body remains coupled between the top drive and the tubular string. Other embodiments of this aspect include corresponding computer systems, apparatus, and computer programs recorded on one or more computer storage devices, cach configured to perform the actions of the methods.

One general aspect includes a method for performing a subterranean operation. The method also includes coupling an instrumented sub between a top drive and a tubular string, where the instrumented sub may include an instrumented clamp that is removably attached to a body of the instrumented sub, and where the instrumented clamp is axially spaced away from either end of the body when the instrumented clamp is attached to the body; transmitting one or more communication signals between the instrumented clamp and a rig controller, and removing the instrumented clamp from the body while the body remains coupled between the top drive and the tubular string. Other embodiments of this aspect include corresponding computer systems, apparatus, and computer programs recorded on one or more computer storage devices, each configured to perform the actions of the methods.

### BRIEF DESCRIPTION OF THE DRAWINGS

These and other features, aspects, and advantages of present embodiments will become better understood when the following detailed description is read with reference to the accompanying drawings in which like characters represent like parts throughout the drawings, wherein:

FIG. 1 is a representative partial cross-sectional view of a rig during a subterranean operation with an instrumented sub communicating parameter measurements to the rig, in accordance with certain embodiments;

FIG. 2 is a representative perspective view of an instrumented sub coupled between a tubular string and a top drive, in accordance with certain embodiments;

FIG. 3 is a representative detailed side view of an instrumented sub coupled between a tubular string and a top drive, in accordance with certain embodiments;

FIG. 4A is a representative side view of an instrumented sub with a remote actuator for operating a valve disposed therein, and the sub being coupled to another sub with a valve disposed therein, in accordance with certain embodiments;

FIG. 4B is a representative semi-transparent side view of an instrumented sub with a valve disposed therein, and the sub being coupled to another sub with a valve disposed therein, in accordance with certain embodiments;

FIG. 5A is a representative side view of an instrumented sub with two valves disposed therein, and the sub being coupled to a saver sub, in accordance with certain embodiments;

FIG. 5B is a representative semi-transparent side view of an instrumented sub with two valves disposed therein, and the sub being coupled to a saver sub, in accordance with certain embodiments;

FIG. 6 is a representative perspective semi-transparent view of an instrumented sub with a valve disposed therein, in accordance with certain embodiments;

FIG. 7 is a representative perspective semi-transparent view of an instrumented sub with a valve disposed therein and an exploded view of a removable instrumentation clamp, in accordance with certain embodiments;

FIG. 8 is a representative partially exploded view of a removable instrumentation clamp, in accordance with certain embodiments;

FIG. 9 is a representative translucent side view of a removable instrumentation clamp, in accordance with certain embodiments;

FIG. 10 is a representative perspective semi-transparent view of an instrumented sub with a valve disposed therein, in accordance with certain embodiments; and

FIG. 11 is a partial cross-sectional view of an instrumented sub along line 11-11 of FIG. 6, the sub having a proximity sensor to detect valve positions, in accordance with certain embodiments.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about,” “approximately,” or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described. A significant difference can be when the difference is greater than ten percent (10%).

As used herein, “tubular” refers to an elongated cylindrical tube and can include any of the tubulars manipulated around a rig, such as tubular segments, tubular stands, tubulars, and tubular string. Therefore, in this disclosure, “tubular” is synonymous with “tubular segment,” “tubular stand,” and “tubular string,” as well as “pipe,” “pipe segment,” “pipe stand,” “pipe string,” “casing,” “casing segment,” or “casing string.”

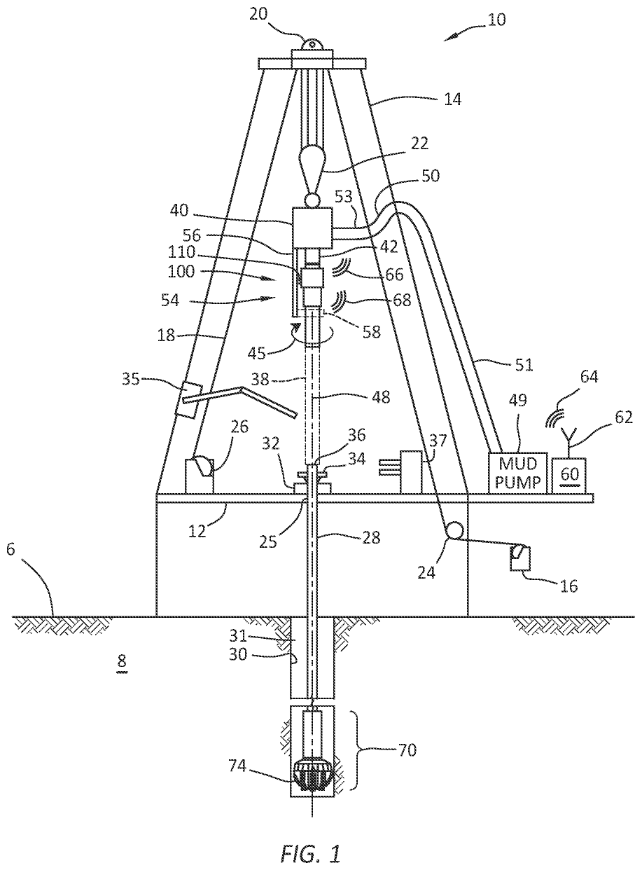

Turning now to the drawings, FIG. 1 is a representative rig 10 in the process of extending a wellbore 30 through a surface 6 and into a formation 8, in accordance with present techniques. The rig 10 features an elevated rig floor 12 and a derrick 14 extending above the rig floor 12. A supply reel 16 supplies line 18 to a crown block 20 and traveling block 22 configured to hoist various types of equipment above the rig floor 12. The line 18 can be secured to a deadline tiedown anchor 24, and a drawworks 26 can regulate the amount of line 18 in use and, consequently, the height of the traveling block 22 at a given moment. Below the rig floor 12, a tubular string 28 extends downward into the wellbore 30 and can be held stationary with respect to the rig floor 12 by slips 34. A portion of the tubular string 28 extends above the rig floor 12, forming a stickup 36 to which another length of tubular 38 may be added. A lower end of the tubular string 28 can include a bottom hole assembly (BHA) 70 which can include one or more drill collars and a drill bit 74.

When a new length of tubular 38 is added to the tubular string 28, a top drive 40, hoisted by the traveling block 22, can position the tubular 38 above the wellbore 30 before coupling the tubular 38 with the tubular string 28. The top drive 40 can utilize a grabber system 54 to hold the tubular 38 while the top drive 40 is coupled to the tubular. The grabber system 54 may include a backup wrench (BUW) support 56 coupled to the top drive 40 and a backup wrench (BUW) 58 coupled to the end of the backup wrench (BUW) support 56 and configured to engage the tubular 38.

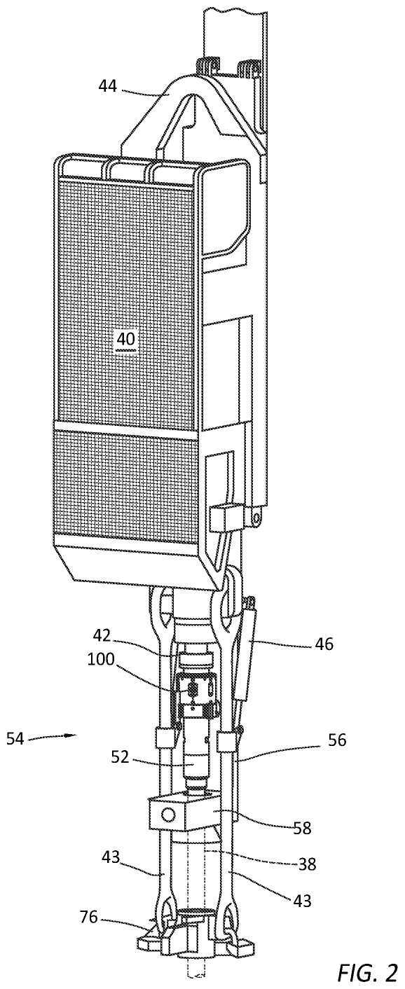

The top drive 40, once coupled with the tubular 38, may then lower the tubular 38 toward the stickup 36 such that the tubular 38 connects with the stickup 36 and becomes part of the tubular string 28. As the tubular 38 is lowered, the top drive 40 may rotate the tubular 38 (arrows 45). Specifically, the top drive 40 can include a quill 42 and an instrumented sub 100. The tubular 38 may be coupled to the instrumented sub 100, which can be coupled to the quill 42. In certain embodiments, a saver sub 72, 52 or a manual (or remote) internal blowout preventor (IBOP) sub 52 (see FIG. 2) may be coupled between the tubular 38 and the instrumented sub 100 to protect the mating threads of the instrumented sub 100 or provide a safety shutoff valve for detected events, such as kicks or blowouts. The top drive 40 can include a hoist support 44 used to couple to a traveling block 22 for raising and lowering the top drive.

Further, the top drive 40 can couple to the tubular 38 in a manner that enables translation of motion to the tubular 38. Indeed, in the illustrated embodiment, the top drive 40 is configured to supply torque for making-up and breaking-up a coupling between the tubular 38 and the stickup 36. However, torque for making-up or breaking-up a coupling between the tubular 38 and the stickup 36 can alternatively, or in addition to, be supplied by other equipment, such as a pipe handler 35 or an iron roughneck 37.

To facilitate the circulation of mud or other drilling fluid within the wellbore 30, the rig 10 can include a mud pump 49 configured to pump mud or drilling fluid up to the top drive 40 through a mud hose 50. In certain embodiments, the mud hose 50 may include a standpipe 51 coupled to the derrick 14 in a substantially vertical orientation to facilitate pumping of mud. The standpipe 51 provides a high-pressure path for mud to flow up the derrick 14 to the top drive 40. From the mud hose 50 (e.g., standpipe 51), the mud flows through a kelly hose 53 to the top drive 40. From the top drive 40, the drilling mud will flow through internal passages of the instrumented sub 100, into internal passages of the tubular 38 and the tubular string 28, to drill bit 74 coupled to the bottom of the tubular string 28. The drilling mud flows within the wellbore 30 (e.g., in an annulus 31 between the tubular string 28 and the wellbore 30) and back to the surface where the drilling mud may be recycled (e.g., filtered, cleaned, and pumped back up to the top drive 40 by the mud pump 49).

When a new tubular 38 is to be added to the tubular string 28, mud flow from the mud pump 49 and the mud hose 50 can be stopped, and the top drive 40 decoupled from the tubular string 28 and raised by the traveling block 22 (e.g., raised the length of tubular 38 to be added to the tubular string 28). When the top drive 40 releases the tubular string 28, mud within the top drive 40 may run out of the top drive 40 and onto the rig floor 12. To avoid spilling mud onto the rig floor 12, the instrumented sub 100 can include a mud saver valve to block mud from inadvertently flowing out of the top drive 40 when the top drive along with the instrumented sub 100 is decoupled from the tubular string 28. When the top drive 40 is thereafter coupled to the new tubular 38 just added to the tubular string 28 and the mud pump 49 resumes a pumping operation, the mud saver valve of the instrumented sub 100 may again enable flow of mud through the instrumented sub 100 and the top drive 40 to the tubular 38 and tubular string 28.

The rig controller 60 may be configured to regulate operation of the mud pump 49 and/or other features of the rig 10. For example, the rig controller 60 may be configured to regulate a flow rate of mud or other drilling fluid circulated through the tubular string 28 and the wellbore 30 during installation of tubular elements (e.g., tubular 38). For example, the rig controller 60 may regulate operation of the mud pump 49 to start, stop, increase, and/or decrease mud flow into the tubular string 28 and wellbore 30 during installation of tubular 38 clements. The rig controller 60 may also regulate other components of the rig 10 to control flow of drilling mud or receive sensor data from surface and downhole sensors. For example, the rig controller 60 may receive wirelessly transmitted data 68 from the instrumented sub 100 or transmit wirelessly transmitted data 68 to the instrumented sub 100, which can detect and transmit various rig operation parameters such as torque applied by the top drive 40, rotational parameters of the tubular string 28, various sensor data (such as sensor to determine toolface), vibration signals traveling through the tubular string 28, and possibly mud pulses traveling through the mud in the tubular string 28. The rig controller 60 may also receive wirelessly transmitted data 66 from the top drive 40 via a wireless antenna 62 or send wirelessly transmitted data 64 to either the instrumented sub 100 or the top drive 40.

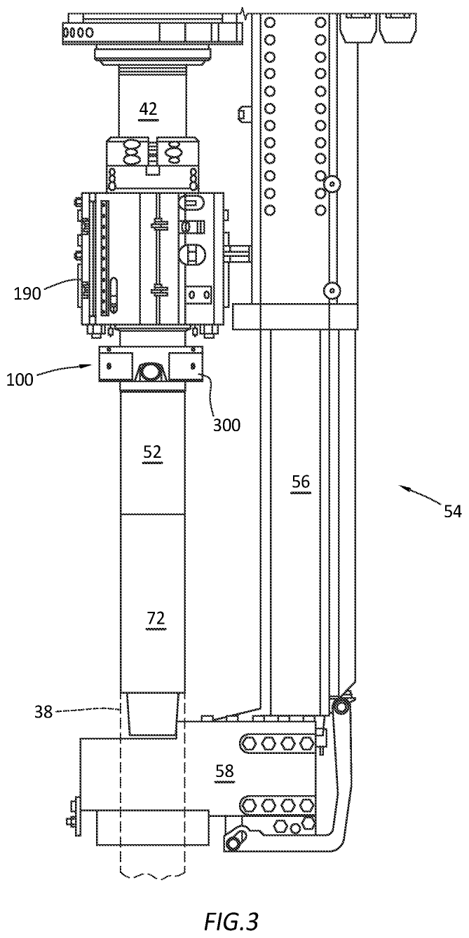

The current disclosure provides a novel instrumented sub 100 that can provide more frequent and more direct measurements than typically available on a rig 10 thus improving accuracy of the measurements, such as hook load, top drive torque, internal pressure of the tubular string 28, differential pressure across the mud saver valve, depth of the tubular string 28, RPM (revolutions per minute), temperature, top drive ranging, angular orientation, etc. The instrumented sub 100 can also provide currently rare or unavailable measurements, such as bend, vibration, shock, state of the mud saver valve, etc. The instrumented sub 100 can include a removable instrumented clamp 300 (see FIG. 3) that allows for removal/replacement of sensors, sub control logic, or energy storage devices. Reattaching the instrumented clamp 300 onto the body can be done after one or more components of the instrumented clamp have been inspected, replaced, refurbished, recharged, had memory downloaded, had updates uploaded, had updated components installed, or combinations thereof. The instrumented sub 100 can be used for all activities involving a top drive (e.g., drilling, casing, logging, etc.)

It should be noted that the illustration of FIG. 1 is intentionally simplified to focus on the instrumented sub 100 (described in more detail below) that can be coupled between the tubular string 28 and the top drive 40. The instrumented sub 100 rotates with the tubular string 28, measures rig operation parameters, and wirelessly communicates the parameters to the rig controller 60. Many other components and tools may be employed during the various periods of formation and preparation of the well. Similarly, as will be appreciated by those skilled in the art, the orientation and environment of the well may vary widely depending upon the location and situation of the formations of interest. For example, rather than a generally vertical bore, the well, in practice, may include one or more deviations, including angled and horizontal runs. Similarly, while shown as a surface (land-based) operation, the well may be formed in water of various depths, in which case the topside equipment may include an anchored or floating platform.

FIG. 2 is a representative perspective view of an instrumented sub 100 coupled between a tubular string 28 and a quill 42 of a top drive 40. A saver sub or internal blowout preventer sub 52 can be coupled between the tubular string 28 and the instrumented sub 100. The top drive 40 can include a hoist support 44 coupled to the traveling block 22 for raising and lowering the top drive 40. A quill 42 can extend below the top drive 40 and couple to the instrumented sub 100. The quill 42 is driven by the top drive 40 to control rotation of the tubular string 28. Since the instrumented sub 100 is coupled between the quill 42 and the tubular string 28, the instrumented sub 100 can be used to measure the torque being applied to the tubular string 28 via the top drive 40. It is preferred, that when the instrumented sub 100 and the sub 52 are coupled to the quill 42, the backup wrench 58 of the grabber system 54 can extend below the sub 52 so the backup wrench 58 can engage the box end of the tubular 38 for making-up or breaking-up a connection of the tubular 38 to the sub 52 (when used) or the instrumented sub 100 when the sub 52 is not used. The elevator 76, the pair of links 43, and the link tilt actuators 46 can be used to hoist the tubular 38 to align with the center axis 48 (sec FIG. 1) of the tubular string 28.

FIG. 3 is a representative side view of an instrumented sub 100 coupled between a tubular string 28 and a quill 42 of a top drive 40. In a certain embodiment, a saver sub 72 and a sub 52 (e.g., with an IBOP or lower well control valve LWCV) can be coupled between the tubular string 28 and the instrumented sub 100. The instrumented sub 100 can include a valve that can be remotely operated by a remote actuator 190. The remote actuator 190 can clamp around the instrumented sub 100 to actuate the valve. The remote actuator 190 is coupled to the grabber system 54 and does not rotate with the instrumented sub 100. When the valve is to be actuated, the remote actuator 190 can be positioned over the valve portion of the instrumented sub 100 to engage drive shafts of the valve. The instrumented sub 100 can include an instrumented clamp 300 that can be removably attached to the body of the instrumented sub 100. The instrumented clamp 300 can provide one or more sensors for measuring drill string parameters as well as environmental parameters.

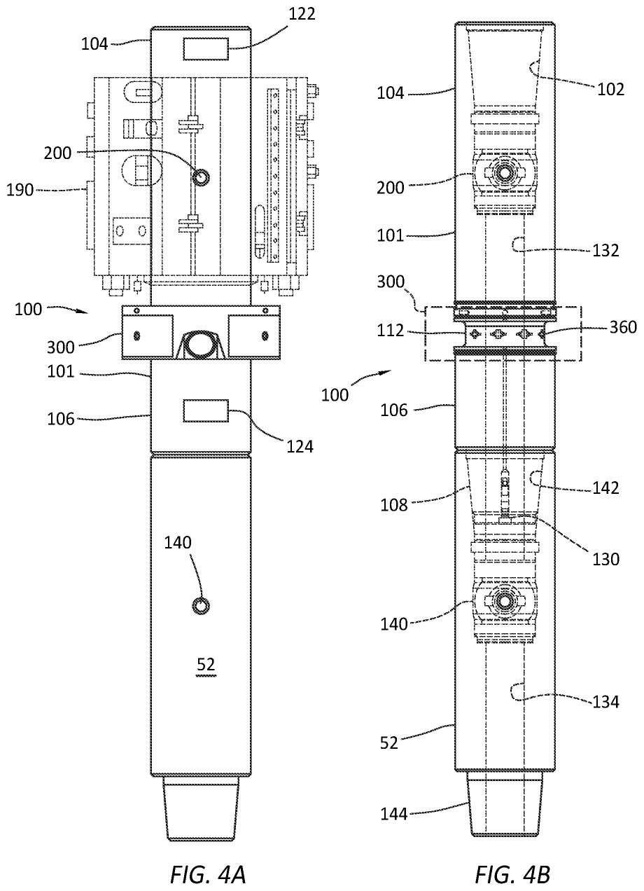

FIGS. 4A and 4B are representative side views of an instrumented sub 100 attached to a sub 52 having a valve 140 disposed therein (e.g., an IBOP or LWCV). This assembly is shown without the top drive 40 or the tubular 38 or saver sub 72 for clarity. The instrumented sub 100, a body 101 which can include a box end 102 for coupling to the quill 42 of the top drive 40; an upper portion 104 (which can contain a valve 200 in certain embodiments, such as an UWCV); a lower portion 106 (which can contain a valve 140 in certain embodiments but not shown in this embodiment); and a pin end 108 that can be used to couple to a box end 142 of sub 52, or a tubular string 28. The body 101 can include strain gauges 360 in an annular groove 112 that is axially positioned between the body portions 104, 106. These strain gauges can be calibrated by torquing the upper portion 104 relative to the lower portion 106, via the calibration coupling features 122, 124. By securing a hold wrench (not shown) to the lower portion 106 via the calibration coupling feature 124, rotation of the lower portion 106 relative to the hold wrench can be prevented. By securing a torque wrench (not shown) to the upper portion 104 via the calibration coupling feature 122, rotation of the upper portion 104 relative to the torque wrench can be prevented.

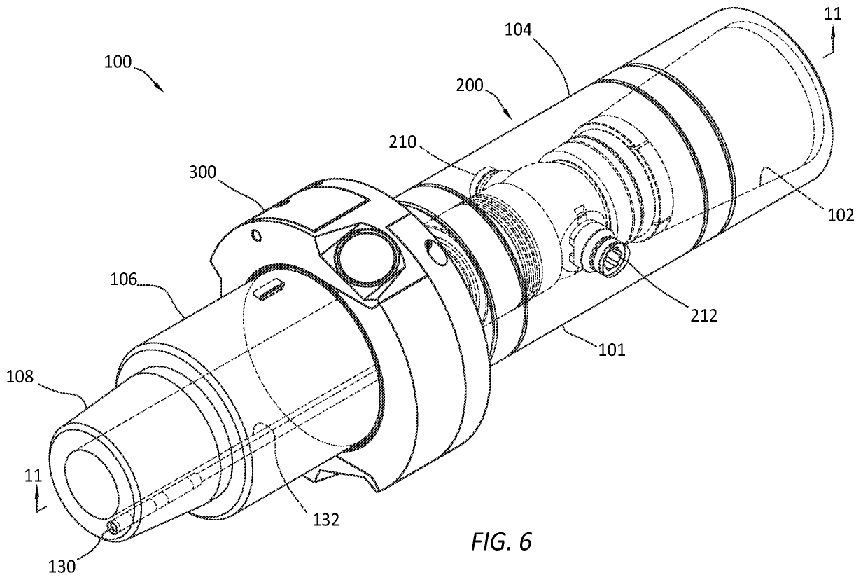

Therefore, when the torque wrench is rotated relative to the hold wrench, the upper portion 104 will tend to rotate relative to the lower portion 106, thereby causing strain on the instrumented sub 100 between the upper and lower portions 104, 106. The strain gauges positioned in the annular groove 112 can sense the torque being applied to the upper portion 104. With a known torque being applied to the upper portion 104, the strain gauges and the control electronics (e.g., in the instrumented clamp 300) that receive sensor information from the strain gauges can be calibrated and then used to sense an unknown torque applied to the upper portion 104 via the top drive (for example). Similarly, strain gauges that are sensitive to axial loads can be calibrated and utilized for measuring hook load (i.e., tension on the instrumented sub 100), compression on instrumented sub 100, bending forces on the instrumented sub 100, etc. The valve 200 can be actuated manually via the drive shafts 210, 212 (see FIG. 6) or remotely controlled via the remote actuator 190, which can remotely operate the drive shafts 210, 212.

In a certain embodiment, the instrumented sub 100 can be coupled to a sub 52 having a valve 140 (e.g., a LWCV or IBOP 140) disposed therein. The pin end 108 of the instrumented sub 100 can be mated with the box end 142 of the sub 52. An internal flow passage 132 of the instrumented sub 100 can align with an internal flow passage 134 of the sub 52 to provide a flow passage through the assembly, where flow of fluid through the flow passages can be selectively interrupted by the valves 200, 140. In a certain embodiment, the valve 200 can be used as a mud saver valve to limit spillage of drilling fluid when connections of the tubular string 28 are made up or broken up and the valve 140 can be utilized as an IBOP to help manage events such as kicks or blow outs. However, these valves can also be used for other purposes regarding flow control through the instrumented sub 100 and subs 52, 72. The box end 102 of the instrumented sub 100 can be used to couple to the quill 42 of the top drive 40, while the pin end 144 of the sub 52 can be used to couple the sub 52 to a saver sub 72, a tubular 38, or a tubular string 28. The strain gauges 360 in the annular groove 112 and other sensors in the instrumented clamp 300 can be used to monitor various rig operation parameters (e.g., weight on bit WOB, revolutions per minute RPM, rate of penetration ROP, torque, pressures, temperatures, vibrations, azimuthal orientation, toolface, etc.).

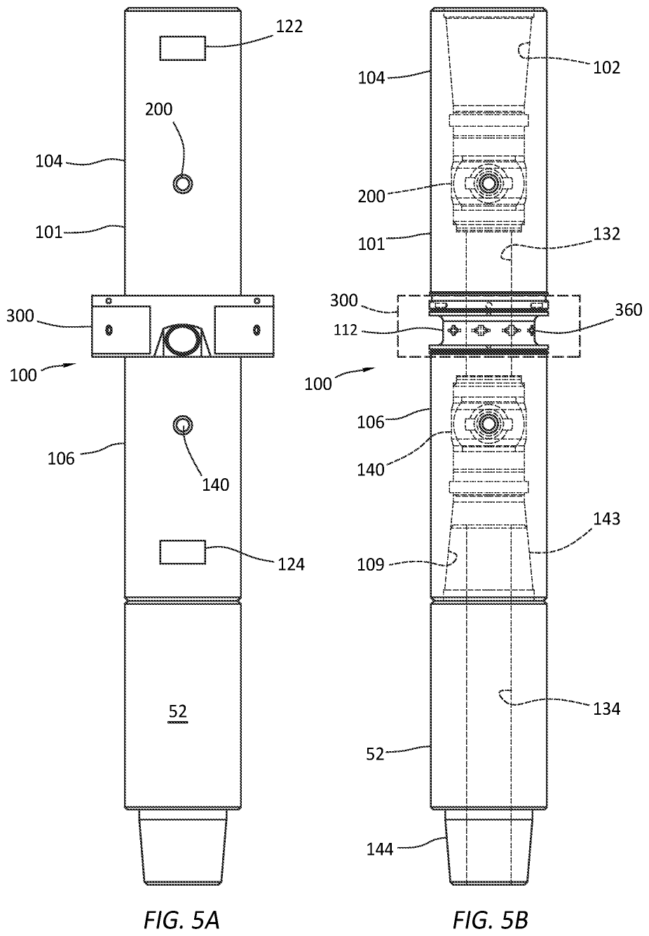

FIGS. 5A and 5B are representative side views of an instrumented sub 100 attached to a sub 52 without having a valve 140 disposed therein. This assembly is shown without the top drive 40 or the tubular 38 or saver sub 72 for clarity. The instrumented sub 100, a body 101 which can include a box end 102 for coupling to the quill 42 of the top drive 40; an upper portion 104 that can contain a valve 200 (e.g., a UWCV 200); a lower portion 106 (which can contain a valve 140 in certain embodiments but not shown in this embodiment); and a pin end 108 that can be used to couple to a box end 142 of sub 52, or a tubular string 28. The body 101 can include strain gauges 360 in an annular groove 112 that is axially positioned between the body portions 104, 106. These strain gauges can be calibrated by torquing the upper portion 104 relative to the lower portion 106, via the calibration coupling features 122, 124, as described above regarding FIGS. 4A and 4B. The valve 200 can be actuated manually via the drive shafts 210, 212 (see FIG. 6) or remotely controlled via the remote actuator 190, which can remotely operate the drive shafts 210, 212.

In a certain embodiment, a box end 109 of the instrumented sub 100 can be mated with the pin end 143 of the sub 52. An internal flow passage 132 of the instrumented sub 100 can align with an internal flow passage 134 of the sub 52 to provide a flow passage through the assembly, where flow of fluid through the flow passages can be selectively interrupted by the valves 200, 140. In a certain embodiment, the valve 200 can be used as a mud saver valve to limit spillage of drilling fluid when connections of the tubular string 28 are made up or broken up and the valve 140 can be utilized as an IBOP to help manage events such as kicks or blow outs. However, these valves can also be used for other purposes regarding flow control through the instrumented sub 100 and subs 52, 72. The box end 102 of the instrumented sub 100 can be used to couple to the quill 42 of the top drive 40, while the pin end 144 of the sub 52 can be used to couple to the sub 52 to a saver sub 72, a tubular 38, or a tubular string 28. The strain gauges 360 in the annular groove 112 and other sensors in the instrumented clamp 300 can be used to monitor various rig operation parameters (e.g., weight on bit WOB, revolutions per minute RPM, rate of penetration ROP, torque, pressures, temperatures, vibrations, azimuthal orientation, toolface, etc.).

FIG. 6 is a representative perspective semi-transparent view of an instrumented sub 100 with a valve 200 disposed therein. The valve 200 can be operated by rotating the drive shafts 210, 212, which in turn rotate a ball between closed, opened, or partially opened positions to control flow of fluid through the flow passage 132. The instrumented clamp 300 is installed such that it surrounds the annular groove (or at least surrounds a major portion of the annular groove 112).

In certain embodiments, the pressure sensor 130 can be disposed in the pin end 108 or in any other position that is exposed to fluid flow in the passage 134 of the lower portion 106. When the instrumented sub 100 is coupled to the tubular string 28 (such as directly or through a sub 52), the pressure sensor 130 can be in fluid communication with the internal flow passage 134 of instrumented sub 100 downstream from the valve 200. This allows the instrumented sub 100 to measure the internal fluid pressure of the tubular string 28. With another pressure sensor (not shown) in fluid communication with the flow passage 132 upstream from the valve 200, a differential pressure across the valve 200 can be directly measured, which is beneficial to rig operations.

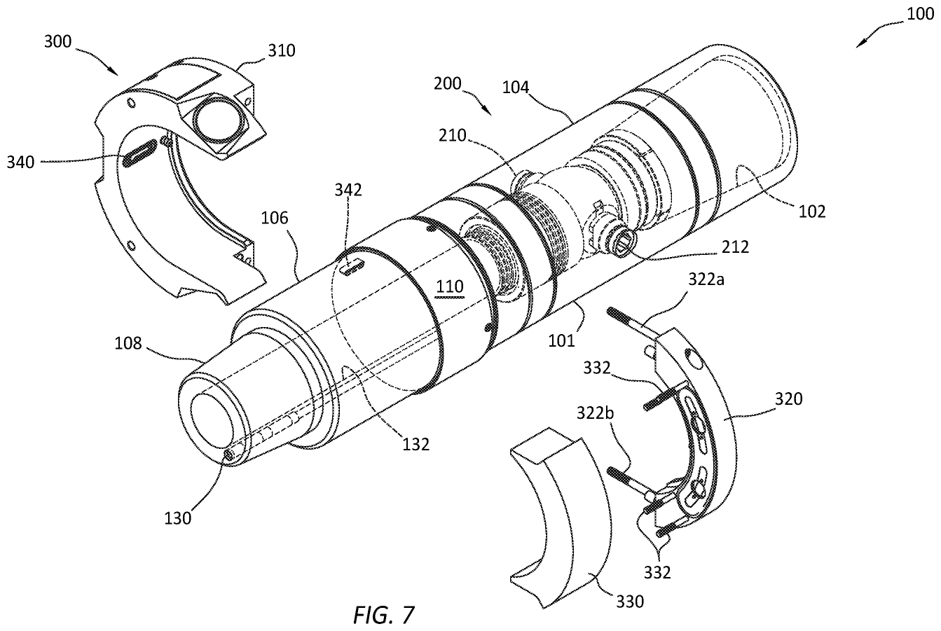

FIG. 7 is a representative perspective semi-transparent view of an instrumented sub 100 with a valve 200 disposed therein and an exploded view of a removable instrumentation clamp 300. The instrumented clamp 300 can include a control portion 310, an electrical coupling portion 320, and an energy storage portion 330. These portions can be formed as arcuate portions, and when fitted together can form a generally circular instrumented clamp 300 that can at least partially surround the body 101. The circular instrumented clamp 300 can be referred to as a circular assembly, even if there are gaps in the circle formed by the assembly. For example, if the instrumented clamp 300 is formed of separate arcuate portions 310, 320 that can be fastened directly to the body 101, but have gaps between them, this can still be seen as circular. Therefore, as used herein, “circular assembly” refers to an assembly that, when assembled to the body 101, overlays at least 75% of the outer circumferential distance of the body 101 at the axial position on the body 101 where the assembly is attached.

In a certain embodiment, the portions 310, 320, and 330 can be fastened together with fasteners to form a circular assembly that clamps around the body 101. A protective sleeve 110 can be installed over the annular groove 112. A connector 342 disposed in the protective sleeve 110 can be electrically coupled to sensors (e.g., strain sensors 360) disposed in the annular groove 112. When removably attached to the body 101, the portion 310 can be electrically coupled to the connector 342 via a mating connector 340 on the portion 310. Mating the connectors 340 and 342 can cause the electronics in the portion 310 to be communicatively coupled to the sensors in the annular groove as well as any other sensors disposed in the body 101 (e.g., a proximity sensor for the valve 200, a barometric pressure sensor in fluid communication with an external environment from the body 101, a pressure sensor such as sensor 130, etc.).

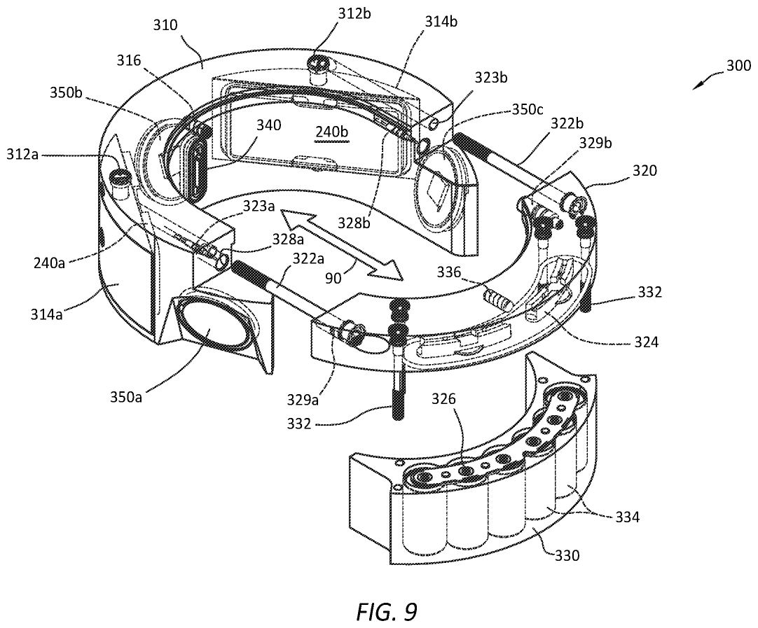

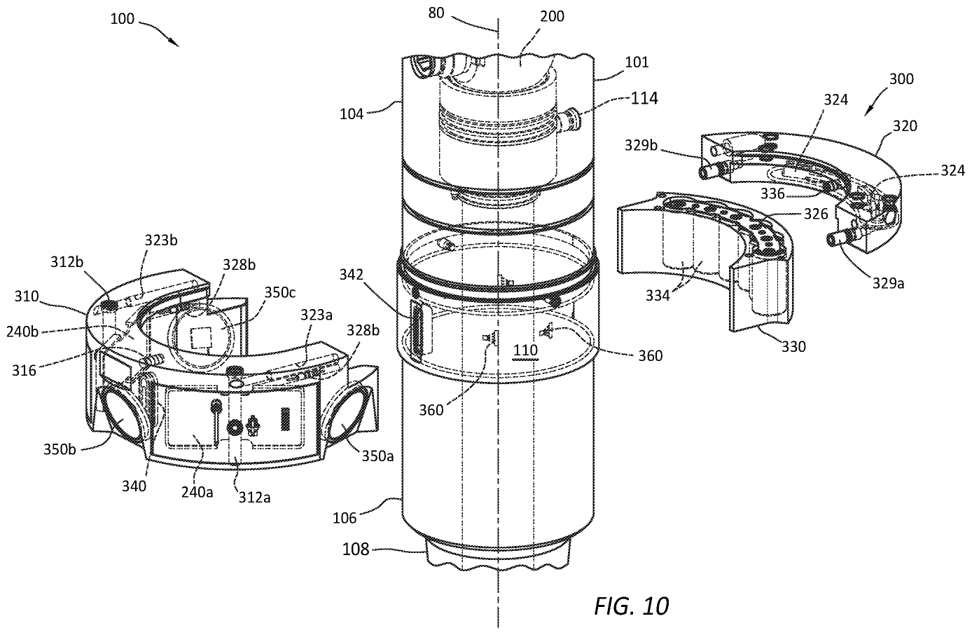

When the instrumented clamp 300 is assembled onto the body 101, the fasteners 322a, 322b can secure the portion 320 to the portion 310 (e.g., by threading the fasteners 322a, 322b into threaded bores in the portion 310). Fasteners 332 can be used to secure the portion 330 to the portion 320. However, it should be understood that other types of fasteners can also be used to secure these portions 310, 320, 330 together to form the instrumented clamp 300, such as twist lock fasteners, latch fasteners, resilient latch fasteners, etc. It should also be understood that the fasteners 322a, 322b can be used to removably secure the portions 320, 330 directly to the body 101 with additional fasteners being utilized to removably secure the portion 310 directly to the body 101. The portions 320, 330 can still be electrically coupled to the portion 310 via the electrical couplings 329a, 329b coupled to the respective electrical couplings 328a, 328b (sec FIGS. 9 and 10).

The each of the portions 310, 320, 330 can include a unique identifier (e.g., an identification chip, a radio frequency identification RFID chip, a remotely sensed identification device, etc.) that allows unique information or parameters to be stored in a database in association with the unique identifier. The sensors in the portions 310, 320, 330 can be different and may cause a portion to be recalibrated when a different calibrated sensor is installed in the portion in place of another sensor. Additionally, the storage devices in the portion 330 can also be different (e.g., capacitor, battery, various sizes of capacitors, various sizes of batteries, various charge levels for each capacitor or battery, rechargeable storage device, non-rechargeable storage device, etc.) The unique information or parameters can be stored in a database coupled to the rig controller 60 (or another remote controller, such as a lab test controller) and wirelessly communicated to the instrumented sub 100 based on their unique identifiers.

For example, while assembling the instrumented sub 100 in a shop or in the field, the instrumented sub 100 can know the unique information or parameters for each portion 310, 320, 330 based on their unique identifiers. The instrumented sub 100 can apply correct calibration parameters of the sensors (e.g., in the body 101), monitor the usage of the storage devices 334 and update the remaining charge information to the rig controller 60. The storage devices 334 or the portion 330 can be utilized later in a different assembly.

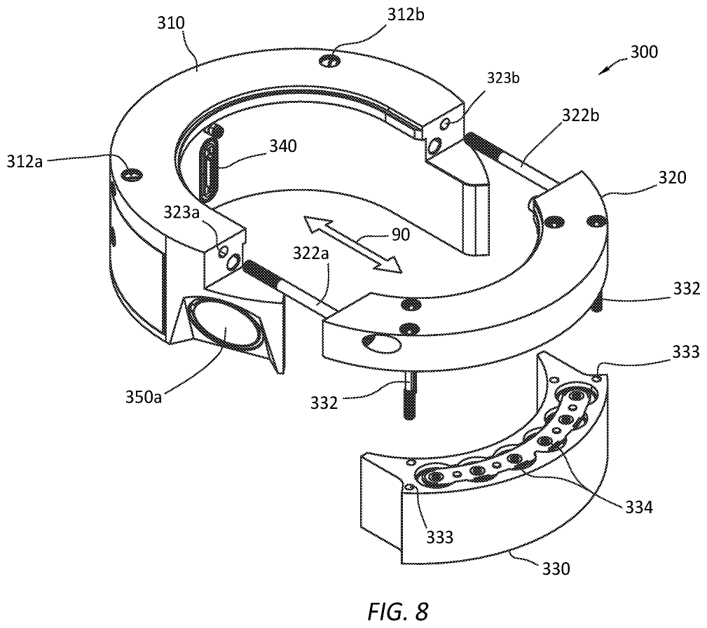

FIG. 8 is a representative partially exploded view of a removable instrumentation clamp 300 of the instrumented sub 100, such as some embodiments shown in FIGS. 3-7. The exploded view of the instrumented clamp 300 is shown without the body 101 of the instrumented sub 100 for clarity. When assembling the instrumented clamp 300 to the body 101, the portions 310 and 320 can be moved toward each other (arrows 90) such that the fasteners 322a, 322b are aligned and inserted in the respective bores 323a, 323b. In this embodiment, the fasteners 322a, 322b can be threaded into a threaded portion of the respective bores 323a, 323b to secure the portions 310, 320 on opposite sides of the body 101, where the portions 310, 320 can cach at least partially extend around a portion of the body 101 to contact each other when assembled, or where a gap between the two portions can remain after the instrumented clamp 300 is removably attached to the body 101.

When the portion 310 is moved toward the body 101 and toward the portion 320 (arrows 90), the connector 340 can blind mate with the connector 342 on the protective sleeve 110 to electrically couple the electric components in the instrumented clamp 300 to electric components in the body 101. The portion 330, which can contain one or more energy storage devices 334, can be assembled to the portion 320 via one or more fasteners 332 installed through the portion 320 and threadably engaged with respective bores 333 in the portion 330. When the portion 330 is attached to the portion 320, the energy storage devices 334 can be electrically coupled to portion 310 through the electrical couplings of the portion 320.

FIG. 9 is a representative translucent side view of a removable instrumentation clamp 300 of the instrumented sub 100, such as some embodiments shown in FIGS. 3-8. In a certain embodiment, one or more antennas 350a, 350b, 350c can be distributed around the outer perimeter of the portion 310. These antennas 350a, 350b, 350c can be used to transmit and receive wireless communications between the rig controller 60 or other communication equipment on or off the rig 10. The antennas 350a, 350b, 350c can be communicatively coupled to the electronic modules 240a, 240b, which can provide control for the instrumented sub 100 as well as collecting, processing, and transmitting sensor data from the sensors in the instrumented sub 100.

The electronic modules 240a, 240b can send raw sensor data via the wireless communications or they can process the sensor data and send results via the wireless communications. The electronic modules 240a, 240b can also receive data and control information from the rig controller 60 via the wireless communications and can use this received data in the processing of the sensor data from the instrumented sub 100.

The electronic modules 240a, 240b can be removably installed in recesses formed in an outer perimeter of the portion 310. The electronic modules 240a, 240b can be held in their respective recesses by one or more respective fasteners 312a, 312b and respective recess covers 314a, 314b.

Guide pin 316 can be used to align the portion 310 with the protective sleeve 110 and the mating connector 342. The guide pin 316 can also retain the instrumented sub 100 in its axial position when it is assembled to the body 101. The guide pine 336 can be used, along with the fasteners 322a, 322b to align the portion 320 with the portion 310 such that the electrical couplings 329a, 329b align with the respective electrical couplings 328a, 328b and couple to each other when the instrumented clamp 300 is assembled to the body 101.

When the portion 330 is attached to the portion 320 via the fasteners 332, the energy storage devices 334 can be electrically coupled to the rest of the instrumented clamp 300 via the electrical couplings 324, 326, which can mate together and provide an electrical coupling between the portion 320 and the portion 330.

FIG. 10 is a representative perspective semi-transparent exploded view of an instrumented sub 100 with a valve 200 disposed therein. The protective sleeve 110 is positioned over the annular groove 112, with strain gauges 360 disposed in the annular groove 112. The protective sleeve 110 sealingly engages the body 101 and can form a sealed chamber formed by the protective sleeve 110 and the annular groove 112. The protective sleeve 110 can be rotationally fixed to the body portion 104, while allowing rotation relative to the portion 106. This allows the body portion 106 to rotate relative to the body portion 104, such that the strain gauges 360 can detect rotation, bending, compression, or tension between the body portion 104 and the body portion 106. The strain gauges 360 and any other sensors in the body 101 can be electrically coupled to the instrumented clamp 300.

The electronics modules 240a, 240b can provide control and processing for sensor data collected from the rig and from the instrumented sub 100. The antennas 350a, 350b, 350c can be communicatively coupled to the electronic modules 240a, 240b. The antennas 350a, 350b, 350c can be tilted relative to the center axis 80 and positioned at spaced apart azimuthal positions around the perimeter of the portion 310.

The instrumented sub 100 can be used to provide measurements of the top drive outputs and drilling parameters which can be used in a feedback control of a top drive 40 as well as azimuthal orientations and axial positions of the quill 42, and axial, tortional, and bending loads acting upon the tubular string 28. The instrumented sub 100 can provide real-time transmission of various parameters measured with high sampling rate and on-board processing (e.g., via the electronic modules 240a, 240b). The instrumented sub 100 can also provide a direct electrical interface via a test port 114 which can be used to electrically couple external equipment to the instrumented sub, 100 to upload data to the instrumented sub 100, download data from the instrumented sub 100, perform self-tests on the instrumented sub 100, perform calibration activities for the instrumented sub 100, etc.

The instrumented sub 100 can provide detachable instrumentation and power sections allowing, in the well control situations, to strip down the tubular string 28 to its nominal OD that can pass through a backup wrench 58 of the top drive 40. The instrumented sub 100 can provide on-site calibration of torque, hook load, and depth sensors of the top drive 40. The instrumented sub 100 can provide fatigue life and health monitoring of the top drive 40 and mud pumps 49. In certain embodiments, the instrumented sub 100 can measure a torsional force, a tensile force, a compression force, or combinations thereof acting on one of the upper portion 104 or the lower portion 106 relative to the other one of the upper portion 104 or the lower portion 106.

In certain embodiments, the instrumented sub 100 can measure vibration, shock, pressures, and temperatures as well as displacement of the tubular string 28. In certain embodiments, the instrumented sub 100 can be utilized to decode mud-pulse telemetry transmitted through the tubular string 28. In certain embodiments, the instrumented sub 100 can provide spectroscopy of noises from mud pumps 49 or the top drive 40. In certain embodiments, the instrumented sub 100 can provide state detection (e.g., open, closed, or partially closed) of the valves 140, 200 when included in the instrumented sub 100. By removing the instrumented clamp 300 of the instrumented sub 100, the body 101 can pass through the backup wrench 58 (e.g., in well control situations).

In certain embodiments, the instrumented sub 100 can include one or more accelerometers, magnetometers, gyros, and temperature sensors. These sensors can be mounted on printed circuit assemblies of the electronic modules 240a, 240b or directly attached to a housing of the instrumented clamp 300, which can be rigidly clamped onto the tubular string 28, thereby configured to transfer well vibration and shock loads the tubular string 28 is subjected to.

In certain embodiments, the portion 330 is attached to the portion 320 to form a portion of the instrumented clamp 300. When the portion 320 (with the portion 330 attached) is attached to the portion 310, the electrical couplings 329a, 329b provide sealed contacts that mate with corresponding electrical couplings 328a, 328b of the portion 310. The housing of each electrical coupling 329a, 329b can act as a sealed key helping to pre-align the portions 310, 320 and establish a seal with the bores 323a, 323b from the environment prior to making electrical contact between the electrical couplings 328a, 328b and the electrical couplings 329a, 329b. This safety feature can insure sparkless engagement and disengagement of the portions 310, 320.

In certain embodiments, the instrumented sub 100 can provide sensors to measure hook load, torque, and bend of the tubular string 28 as well as to track stresses and fatigue loads on a quill 42. The bending moment applied to the quill 42 can be used to alert the rig crew that the top drive 40 is not aligned properly with well center 25 or the stump 36.

In certain embodiments, the instrumented sub 100 can provide shock and vibration measurements within the sub to monitor the severity of a drilling environment. Top hole drilling is rough on a top drive 40 because the tubular string 28 may not have the mass required to drill. In some cases, the weight of the top drive 40 and blocks are used to supply the weight on the drill bit 74 versus heavy weight drill collars. Basalt, gravel, boulders, and other rocks create significant forces on the top drive 40 that the instrumented sub 100 can detect and warn the crew of forces that could damage the top drive 40 and other equipment.

In certain embodiments, the instrumented sub 100 can include AC and DC accelerometers to monitor shock, vibration, acceleration, displacement, acoustic noise, and the orientation of the instrumented sub 100 relative to a gravity vector.

In certain embodiments, the instrumented sub 100 can include magnetometers and gyros to sense the special orientation of the quill 42, RPM of the tubular string 28, and proximity to magnetic objects.

In certain embodiments, the instrumented sub 100 can a barometric pressure sensor and its fusion with accelerometer and gyros data can be used to estimate relative vertical displacement of the top drive 40.

In certain embodiments, the instrumented sub 100 can include strain gauges 360 that can detect and flag time intervals when the entire tubular string 28 is hanging off the top drive 40. During these time intervals, a barometric sensor can detect relative change in the vertical position of instrumented sub 100. Summation of the vertical intervals (when the tubular string 28 is hanging off the top drive 40) can yield a depth of a drill bit 74. The drill bit depth can be unaffected by a floating quill 42.

In certain embodiments, the instrumented sub 100 can include Hall effect sensors, such that when a rotating component of the valve 200 (which can contain a permanent magnet) is rotated to open or close the valve 200, the changing vector of the magnetic field in the location of a Hall effect sensor can be used to track the valve orientation.

In certain embodiments, the instrumented sub 100 can include a retrievable memory device to enable localized recording of data, particularly where the data bandwidth requirements exceed the throughput of the wireless antennas 350a, 350b, 350c, or the link to the wireless antennas 350a, 350b, 350c is unreliable. This memory device can be retrieved when the instrumented sub 100 is not rotating.

In certain embodiments, the instrumented sub 100 can include a flowmeter to measure mud-flow parameters and characteristics of mud flowing through the internal flow passage 132.

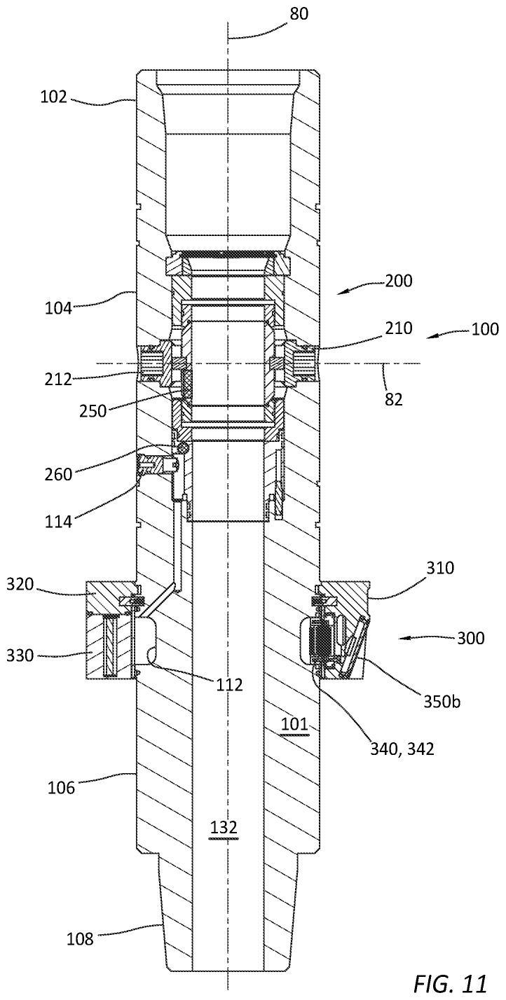

FIG. 11 is a partial cross-sectional view of an instrumented sub 100 as seen along line 11-11 of FIG. 6, the sub having a proximity sensor 260 to detect positions of the valve 200. The valve 200 can be rotated between open and closed positions to control fluid flow through the flow passage 132. A permanent magnet 250 can be installed in a portion of the valve 200 such that the permanent magnet 250 moves when the valve is rotated about the axis 82 between open and closed positions via drive shafts 210, 212. Movement of the permanent magnet 250 can change the vector of a magnetic field in the location of a Hall effect sensor 260, which can be used to track the orientation of the valve 200.

### VARIOUS EMBODIMENTS

Embodiment 1. An instrumented sub for supporting subterranean operations, the instrumented sub comprising:
a body comprising an upper portion and a lower portion, wherein the body is configured to be coupled between a top drive and a tubular string;
a flow passage extending through the upper portion and the lower portion; and
an instrumented clamp that is removably attached to the body between the upper portion and the lower portion, wherein the instrumented clamp is electrically coupled to the body via a first electrical coupling mated to a second electrical coupling, with the first electrical coupling being mounted to the instrumented clamp and the second electrical coupling being mounted to the body.

Embodiment 2. The instrumented sub of embodiment 1, wherein a first valve is disposed in the upper portion, and wherein the first valve selectively permits or restricts fluid flow through the flow passage.

Embodiment 3. The instrumented sub of embodiment 2, wherein a proximity sensor detects a position of the first valve and communicates the position to the instrumented clamp, and wherein the instrumented clamp communicates the position to a rig controller.

Embodiment 4. The instrumented sub of embodiment 1, wherein a second valve is disposed in the lower portion, and wherein the second valve selectively permits or restricts fluid flow through the flow passage.

Embodiment 5. The instrumented sub of embodiment 4, wherein a proximity sensor detects a position of the second valve and communicates the position to the instrumented clamp, and wherein the instrumented clamp communicates the position to a rig controller.

Embodiment 6. The instrumented sub of embodiment 1, wherein a first valve is disposed in the upper portion, wherein a second valve is disposed in the lower portion, and wherein the first valve and the second valve independently selectively permit or restrict fluid flow through the flow passage.

Embodiment 7. The instrumented sub of embodiment 1, wherein a radially reduced diameter portion of the body forms an annular groove in the body between the upper portion and the lower portion.

Embodiment 8. The instrumented sub of embodiment 7, wherein one or more strain gauges are positioned in the annular groove, and wherein the one or more strain gauges measure a torsional force, a tensile force, a compression force, a bending force, or combinations thereof acting on one of the upper portion or the lower portion relative to the other one of the upper portion or the lower portion.

Embodiment 9. The instrumented sub of embodiment 7, wherein one or more sensors are positioned along the annular groove, and wherein the one or more sensors measures torque applied by the top drive, rotational parameters of the tubular string, sensor data used to determine toolface, vibration signals received from the tubular string and top drive, weight of the tubular string, or a combination thereof.

Embodiment 10. The instrumented sub of embodiment 7, wherein a protective sleeve is mounted to one of the upper portion and the lower portion, and wherein the protective sleeve surrounds the annular groove and is at least partially aligned axially on the body with the annular groove.

Embodiment 11. The instrumented sub of embodiment 1, wherein the instrumented clamp further comprises a first arcuate portion and a second arcuate portion that are disposed on opposite sides of the body when the instrumented clamp is removably attached to the body.

Embodiment 12. The instrumented sub of embodiment 11, wherein the first arcuate portion is removably attached to the second arcuate portion via fasteners that extend from the second arcuate portion into the first arcuate portion or extend from the first arcuate portion into the second arcuate portion.

Embodiment 13. The instrumented sub of embodiment 12, wherein the first arcuate portion and the second arcuate portion engage the body when the first arcuate portion and the second arcuate portion are removably attached to each other.

Embodiment 14. The instrumented sub of embodiment 11, wherein the first arcuate portion is removably attached to the body via one or more first fasteners that threadably engage the body, and wherein the second arcuate portion is removably attached to the body via one or more second fasteners that threadably engage the body.

Embodiment 15. The instrumented sub of embodiment 11, wherein the first arcuate portion comprises control electronics that control communications to a rig controller via wireless telemetry through one or more antennas disposed in the first arcuate portion.

Embodiment 16. The instrumented sub of embodiment 15, wherein a radially reduced diameter portion of the body forms an annular groove in the body between the upper portion and the lower portion, and wherein the control electronics are communicatively coupled to one or more sensors in the annular groove and in the body when the first electrical coupling is mated to the second electrical coupling.

Embodiment 17. The instrumented sub of embodiment 15, wherein the control electronics receives sensor data, processes the sensor data, and communicates results to the rig controller.

Embodiment 18. The instrumented sub of embodiment 11, wherein the second arcuate portion comprises a plurality of energy storage devices and supplies power to the first arcuate portion when the instrumented clamp is removably attached to the body.

Embodiment 19. The instrumented sub of embodiment 18, wherein the second arcuate portion comprises an energy storage portion that is removably attached to an electrical coupling portion.

Embodiment 20. The instrumented sub of embodiment 19, wherein the energy storage portion is removable from the electrical coupling portion while the electrical coupling portion remains attached to the first arcuate portion.

Embodiment 21. The instrumented sub of embodiment 20, wherein the electrical coupling portion electrically couples the energy storage portion to the first arcuate portion.

Embodiment 22. The instrumented sub of embodiment 1, wherein the instrumented clamp comprises electronic circuitry disposed in recesses in the instrumented clamp.

Embodiment 23. The instrumented sub of embodiment 22, wherein the electronic circuitry comprises one of a processor; a microprocessor; a digital signal processor; a field-programmable gate array; a programmable logic device; a state machine; a neural network; machine learning circuitry; non-transitory memory; one or more magnetometers, accelerometers, gyroscopes, temperature sensors, pressure sensors, or strain gauges; control logic; signal conditioners; power distribution circuitry; and a combination thereof.

Embodiment 24. The instrumented sub of embodiment 1, wherein wireless communication signals communicate control signals between a rig controller and an instrumented sub controller.

Embodiment 25. The instrumented sub of embodiment 1, wherein a box end adjacent the upper portion is configured to couple the instrumented sub to the top drive, and wherein a pin end adjacent the lower portion is configured to couple the instrumented sub to a second sub or the tubular string.

Embodiment 26. The instrumented sub of embodiment 1, wherein the instrumented clamp comprises a first arcuate portion, a second arcuate portion, and a third arcuate portion, wherein each of the first arcuate portion, the second arcuate portion, and the third arcuate portion comprises a unique identifier, and wherein unique parameters are stored in a database in association with the unique identifier.

Embodiment 27. The instrumented sub of embodiment 26, wherein the unique parameters associated with the unique identifier is downloaded into the instrumented sub when the instrumented clamp is assembled to the body.

Embodiment 28. The instrumented sub of embodiment 26, wherein the instrumented sub corrects calibration parameters of one or more sensors in the instrumented sub based on the unique parameters.

Embodiment 29. A method for performing a subterranean operation, the method comprising:
coupling a body of an instrumented sub between a top drive and a tubular string;
attaching an instrumented clamp to the body, wherein the instrumented clamp is axially spaced away from either end of the body;
transmitting one or more communication signals between the instrumented clamp and a rig controller; and
removing the instrumented clamp from the body while the body remains coupled between the top drive and the tubular string.

Embodiment 30. The method of embodiment 29, wherein the instrumented clamp comprises one or more energy storage devices, electronic circuitry, one or more sensors, one or more antennas, or a combination thereof.

Embodiment 31. The method of embodiment 30, further comprising collecting, via the instrumented clamp, rig operation parameters from the one or more sensors.

Embodiment 32. The method of embodiment 31, further comprising transmitting the rig operation parameters to a rig controller via the one or more antennas.

Embodiment 33. A method for performing a subterranean operation, the method comprising:
coupling an instrumented sub between a top drive and a tubular string, wherein the instrumented sub comprises an instrumented clamp that is removably attached to a body of the instrumented sub, and wherein the instrumented clamp is axially spaced away from either end of the body when the instrumented clamp is attached to the body;
transmitting one or more communication signals between the instrumented clamp and a rig controller; and
removing the instrumented clamp from the body while the body remains coupled between the top drive and the tubular string.

Embodiment 34. The method of embodiment 33, further comprising:
reattaching the instrumented clamp onto the body after one or more components of the instrumented clamp have been inspected, replaced, refurbished, recharged, had memory downloaded, had updates uploaded, had updated components installed, or combinations thereof.

Embodiment 35. The method of embodiment 33, wherein the transmitting occurs when the tubular string is rotating or stationary.

Embodiment 36. The method of embodiment 33, wherein the transmitting comprises:
collecting, via the instrumented clamp, rig operation parameters from one or more sensors in the instrumented sub; and
transmitting the rig operation parameters to a rig controller via one or more antennas of the instrumented sub.

While the present disclosure may be susceptible to various modifications and alternative forms, specific embodiments have been shown by way of example in the drawings and tables and have been described in detail herein. However, it should be understood that the embodiments are not intended to be limited to the particular forms disclosed. Rather, the disclosure is to cover all modifications, equivalents, and alternatives falling within the spirit and scope of the disclosure as defined by the following appended claims. Further, although individual embodiments are discussed herein, the disclosure is intended to cover all combinations of these embodiments.

What is claimed is:

1. An instrumented sub for supporting subterranean operations, the instrumented sub comprising:
a body comprising an upper portion and a lower portion;
a flow passage extending through the upper portion and the lower portion; and
an instrumented clamp that is removably attached to the body between the upper portion and the lower portion, wherein the instrumented clamp is electrically coupled to the body via a first electrical coupling mated to a second electrical coupling, with the first electrical coupling being mounted to the instrumented clamp and the second electrical coupling being mounted to the body.

2. The instrumented sub of claim 1, wherein a first valve is disposed in the upper portion, and wherein the first valve selectively permits or restricts fluid flow through the flow passage.

3. The instrumented sub of claim 2, wherein a proximity sensor detects a first position of the first valve and communicates the first position to the instrumented clamp, and wherein the instrumented clamp communicates the first position to a rig controller.

4. The instrumented sub of claim 3, wherein a second valve is disposed in the lower portion, and wherein the second valve selectively permits or restricts fluid flow through the flow passage.

5. The instrumented sub of claim 4, wherein a proximity sensor detects a second position of the second valve and communicates the second position to the instrumented clamp, and wherein the instrumented clamp communicates the second position to a rig controller.

6. The instrumented sub of claim 1, wherein a radially reduced diameter portion of the body forms an annular groove in the body between the upper portion and the lower portion.

7. The instrumented sub of claim 6, wherein one or more strain gauges are positioned in the annular groove, and wherein the one or more strain gauges measure a torsional force, a tensile force, a compression force, a bending force, or combinations thereof acting on one of the upper portion or the lower portion relative to the other one of the upper portion or the lower portion.

8. The instrumented sub of claim 6, wherein one or more sensors are positioned along the annular groove, and wherein the one or more sensors measures torque applied by a top drive, rotational parameters of a tubular string, sensor data used to determine toolface, vibration signals received from the tubular string and top drive, weight of the tubular string, or a combination thereof.

9. The instrumented sub of claim 6, wherein a protective sleeve is mounted to one of the upper portion and the lower portion, and wherein the protective sleeve surrounds the annular groove and is at least partially aligned axially on the body with the annular groove.

10. The instrumented sub of claim 1, wherein the instrumented clamp further comprises a first arcuate portion and a second arcuate portion that are disposed on opposite sides of the body when the instrumented clamp is removably attached to the body.

11. The instrumented sub of claim 10, wherein the first arcuate portion and the second arcuate portion engage the body when the first arcuate portion and the second arcuate portion are removably attached to each other.

12. The instrumented sub of claim 10, wherein the first arcuate portion comprises control electronics that control communications to a rig controller via wireless telemetry through one or more antennas disposed in the first arcuate portion.

13. The instrumented sub of claim 10, wherein the second arcuate portion comprises a plurality of energy storage devices and supplies power to the first arcuate portion when the instrumented clamp is removably attached to the body.

14. The instrumented sub of claim 13, wherein the second arcuate portion comprises an energy storage portion that is removably attached to an electrical coupling portion.

15. The instrumented sub of claim 14, wherein the energy storage portion is removable from the electrical coupling portion while the electrical coupling portion remains attached to the first arcuate portion.

16. The instrumented sub of claim 1, wherein a box end adjacent the upper portion is configured to couple the instrumented sub to a top drive, and wherein a pin end adjacent the lower portion is configured to couple the instrumented sub to a second sub or a tubular string.

17. A method for performing a subterranean operation, the method comprising:
coupling a body of an instrumented sub between a top drive and a tubular string;
attaching an instrumented clamp to the body, wherein the instrumented clamp is axially spaced away from either end of the body;
transmitting one or more communication signals between the instrumented clamp and a rig controller; and
removing the instrumented clamp from the body while the body remains coupled between the top drive and the tubular string.

18. The method of claim 17, wherein the instrumented clamp comprises one or more energy storage devices, electronic circuitry, one or more sensors, one or more antennas, or a combination thereof.

19. The method of claim 18, further comprising:
collecting, via the instrumented clamp, rig operation parameters from the one or more sensors; and
transmitting the rig operation parameters to a rig controller via the one or more antennas.

20. The method of claim 17, further comprising:
reattaching the instrumented clamp onto the body after one or more components of the instrumented clamp have been inspected, replaced, refurbished, recharged, had memory downloaded, had updates uploaded, had updated components installed, or combinations thereof.
